(19) United States
(12) Patent Application Publication
(10) Pub. No.: US 2026/0065441 A1
(43) Pub. Date: Mar. 5, 2026

(54) VIDEO PROCESSING SYSTEM, VIDEO PROCESSING METHOD, AND IMAGE QUALITY CONTROL APPARATUS

(71) Applicant: NEC Corporation, Minato-ku, Tokyo (JP)

(72) Inventors: Hayato ITSUMI, Tokyo (JP); Koichi NIHEI, Tokyo (JP); Florian BEYE, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 19/100,984

(22) PCT Filed: Aug. 17, 2022
(86) PCT No.: PCT/JP2022/031076

§ 371 Date: Feb. 4, 2025

(51) Int. Cl. G06T 5/73; G06T 7/00; G06V 10/25; G06V 10/764; G06V 10/98; G06V 20/40; G06V 20/52; G06V 40/20

(52) U.S. Cl. CPC G06T 5/73; G06T 7/0002; G06V 10/25; G06V 10/993; G06V 20/40; G06V 20/52; G06V 40/20; G06T 2207/10016; G06T 2207/30168; G06V 10/764

(57) ABSTRACT

A video processing system includes an image quality control apparatus and a detection apparatus. The image quality control apparatus includes an image quality control unit configured to control image quality of each region of a video, and a transmission unit configured to transmit, to the detection apparatus, the video of which the image quality is controlled. The detection apparatus includes a detection unit configured to detect information regarding an object in the video transmitted from transmission unit, and a notification unit configured to notify the image quality control apparatus of a detection result of the detection unit. The image quality control apparatus further includes a determination unit configured to determine the image quality of each region of the video according to the detection result notified from the notification unit, the image quality being controlled by the image quality control unit.

### TECHNICAL FIELD

The present disclosure relates to a video processing system, a video processing method, and an image quality control apparatus.

### Background Art

There is a technique for performing recognition of an action or an object by analyzing a video captured on-site at a remote place. At that time, in order to suppress a communication load, a region to be focused on is determined by an apparatus installed at a site, image quality of a region other than the region is lowered, and a video is transmitted to a unit that performs analysis.

For example, Patent Literature 1 is known as a related technique. Patent Literature 1 describes a technique for transmitting a video such that image quality of a region gazed at by a viewer is improved in an apparatus that transmits a video via a network.

### CITATION LIST

### Patent Literature

Patent Literature 1: Japanese Unexamined Patent Application Publication No. 2020-43533

### SUMMARY OF INVENTION

### Technical Problem

In the related technique such as Patent Literature 1, the data amount of the video to be transmitted can be reduced to some extent by suppressing image quality of a region other than the gaze region. However, in the related technique, the image quality of the gaze region is always high, so that the data amount may not be appropriately reduced. For example, in a case where there are many gaze regions, there are few regions where the image quality can be degraded, and thus it is difficult to reduce the data amount. In addition, in a case where the image quality of the entire video is lowered, the data amount is lowered, but there is a possibility that a recognition rate is lowered at a reception destination.

In view of such a problem, an object of the present disclosure is to provide a video processing system, a video processing method, and an image quality control apparatus capable of appropriately controlling a data amount of a video.

### Solution to Problem

A video processing system according to the present disclosure includes: an image quality control apparatus; and a detection apparatus. The image quality control apparatus includes an image quality control means for controlling image quality of each region of a video, and a transmission means for transmitting, to the detection apparatus, the video of which the image quality is controlled. The detection apparatus includes a detection means for detecting information regarding an object in the video transmitted from the transmission means, and a notification means for notifying the image quality control apparatus of a detection result of the detection means. The image quality control apparatus further includes a determination means for determining the image quality of each region of the video according to the detection result notified from the notification means, the image quality being controlled by the image quality control means.

A video processing method according to the present disclosure is a video processing method in a video processing system including an image quality control apparatus and a detection apparatus. The image quality control apparatus controls image quality of each region of a video, and transmits, to the detection apparatus, the video of which the image quality is controlled. The detection apparatus detects information regarding an object in the transmitted video, and notifies the image quality control apparatus of the detected detection result. The image quality control apparatus determines the image quality of each region of the video to be controlled, according to the notified detection result.

An image quality control apparatus according to the present disclosure includes: an image quality control means for controlling image quality of each region of a video; a transmission means for transmitting the video of which the image quality is controlled, to a detection apparatus configured to detect information regarding an object in the video; and a determination means for determining the image quality of each region of the video according to a detection result notified from the detection apparatus, the image quality being controlled by the image quality control means.

### Advantageous Effects of Invention

According to the present disclosure, it is possible to provide a video processing system, a video processing method, and an image quality control apparatus capable of appropriately controlling a data amount of a video.

### BRIEF DESCRIPTION OF DRAWINGS

FIG. 1 is a configuration diagram illustrating an outline of a video processing system according to an example embodiment.

FIG. 2 is a configuration diagram illustrating an outline of an image quality control apparatus according to the example embodiment.

FIG. 3 is a configuration diagram illustrating an outline of a detection apparatus according to the example embodiment.

FIG. 4 is a configuration diagram illustrating an outline of the video processing system according to the example embodiment.

FIG. 5 is a diagram for describing an outline of a video processing method according to the example embodiment.

FIG. 6 is a configuration diagram illustrating a basic configuration of a remote monitoring system according to the example embodiment.

FIG. 7 is a configuration diagram illustrating a configuration example of a terminal according to a first example embodiment.

FIG. 8 is a configuration diagram illustrating a configuration example of a center server according to the first example embodiment.

FIG. 9 is a flowchart illustrating an operation example of a remote monitoring system according to the first example embodiment.

FIG. 10 is a flowchart illustrating an operation example of sharpening region switching processing according to the first example embodiment.

FIG. 11 is a diagram for describing video acquisition processing according to the first example embodiment.

FIG. 12 is a diagram for describing object detection processing according to the first example embodiment.

FIG. 13 is a diagram for describing sharpening region determination processing according to the first example embodiment.

FIG. 14 is a diagram for describing the sharpening region switching processing according to the first example embodiment.

FIG. 15 is a diagram for describing the sharpening region switching processing according to the first example embodiment.

FIG. 16 is a configuration diagram illustrating a configuration example of a terminal according to a second example embodiment.

FIG. 17 is a configuration diagram illustrating a configuration example of a center server according to the second example embodiment.

FIG. 18 is a configuration diagram illustrating a configuration example of a terminal according to a third example embodiment.

FIG. 19 is a configuration diagram illustrating a configuration example of a center server according to the third example embodiment.

FIG. 20 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

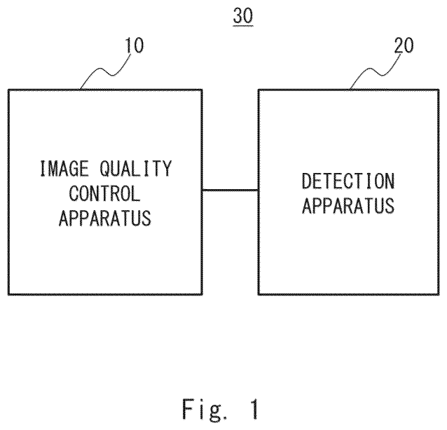

First, an outline of an example embodiment will be described. FIG. 1 illustrates a schematic configuration of a video processing system 30 according to the example embodiment. The video processing system 30 can be applied to, for example, a remote monitoring system that transmits on-site videos via a network and monitors the transmitted videos.

As illustrated in FIG. 1, the video processing system 30 includes an image quality control apparatus 10 and a detection apparatus 20. The image quality control apparatus 10 is an apparatus that controls image quality of a video captured on-site. The detection apparatus 20 is an apparatus that detects an object or the like from a video of which image quality is controlled by the image quality control apparatus 10. For example, the image quality control apparatus 10 may be a terminal, and the detection apparatus 20 may be a server. The image quality control apparatus 10 or the detection apparatus 20 may be mounted on a cloud by using a virtualization technique or the like.

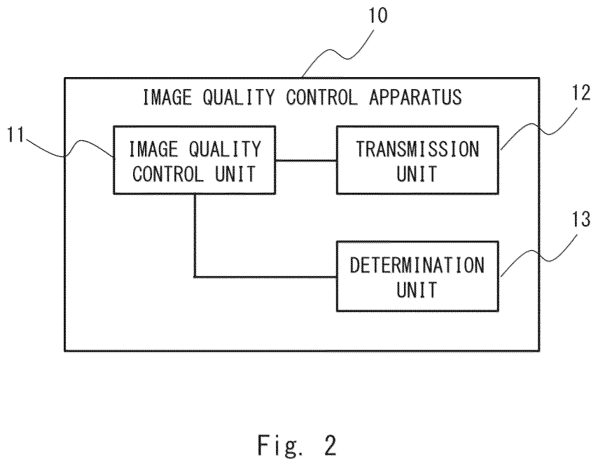

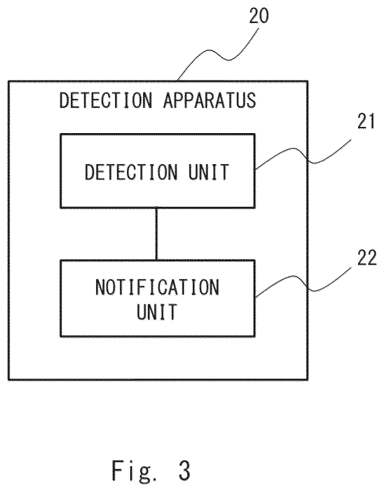

FIG. 2 illustrates a schematic configuration of the image quality control apparatus 10, and FIG. 3 illustrates a schematic configuration of the detection apparatus 20. As illustrated in FIG. 2, the image quality control apparatus 10 includes an image quality control unit 11, a transmission unit 12, and a determination unit 13.

The image quality control unit 11 controls the image quality of each region of a video. For example, the video includes an object such as a person performing work or a work object used by the person in the work, and the image quality control unit 11 controls the image quality of a region including the object. For example, the image quality control unit 11 may sharpen a region including an object or may sharpen a region including an object selected under a predetermined condition. That is, the region including the object may be improved in image quality compared to other regions, and the other regions may be reduced in image quality. The transmission unit 12 transmits the video having the controlled image quality to the detection apparatus 20 via the network.

As illustrated in FIG. 3, the detection apparatus 20 includes a detection unit 21 and a notification unit 22. The detection unit 21 receives the video transmitted from the transmission unit 12, and detects information regarding the object in the received video. For example, the detection unit 21 may detect the object in the video as the information regarding the object, or may recognize an action of the object detected in the video. The notification unit 22 notifies the image quality control apparatus 10 of a detection result of the detection unit 21 via the network. For example, in a case where the detection unit 21 detects the object, the notification unit 22 notifies of the type of the detected object, and in a case where the detection unit 21 recognizes the action of the object, the notification unit 22 notifies of the type of the recognized action of the object.

The determination unit 13 of the image quality control apparatus 10 determines the image quality of each region of the video controlled by the image quality control unit 11, according to the detection result notified from the notification unit 22. The determination unit 13 determines the image quality of each region of the video according to whether the information regarding the object is detected by the detection unit 21. For example, in a case where the detection unit 21 detects an object, the determination unit 13 determines the image quality of each region of the video according to the detection result of the object, and in a case where the detection unit 21 recognizes an action of an object, the determination unit determines the image quality of each region of the video according to the recognition result of the action of the object. In a case where the information regarding the object is detected, the determination unit 13 may change the image quality of the detected region and the image quality of other regions. For example, in a case where an action or an object is detected in the sharpened region, the determination unit 13 determines that no further analysis is required for the detected region, excludes the detected region from the sharpening region, and determines another region as the sharpening region. In other words, the determination unit 13 may determine the detected region as a low image quality region, and determine another region as a high image quality region. In addition, in a case where the information regarding the object is not detected, the determination unit 13 may maintain the image quality of each region of the video. For example, in a case where an action or an object is not detected in the sharpened region, it is determined that analysis is still necessary, and the sharpening of the relevant region is continued.

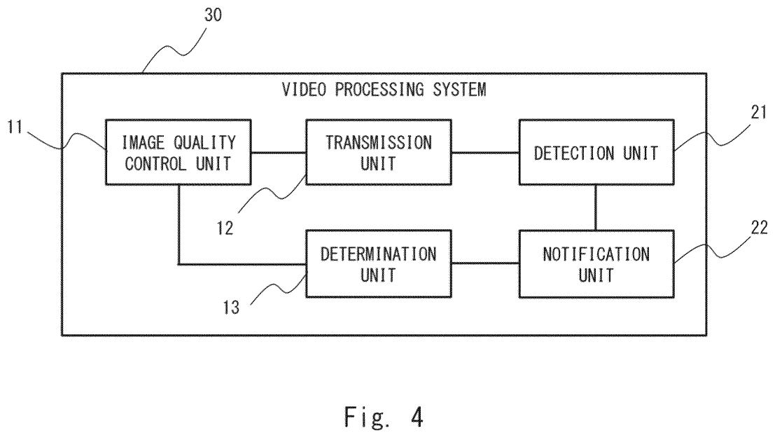

Note that the video processing system 30 may include one apparatus or a plurality of apparatuses. As illustrated in FIG. 4, the video processing system 30 is not limited to the apparatus configuration illustrated in FIGS. 2 and 3, and it is sufficient if the video processing system 30 includes the image quality control unit 11, the transmission unit 12, the determination unit 13, the detection unit 21, and the notification unit 22. A part or the entirety of the video processing system 30 may be disposed on an edge or a cloud. For example, in a system that monitors a video captured on-site via a network, an edge is an apparatus disposed at the site or near the site, and is an apparatus close to a terminal in a hierarchy of the network.

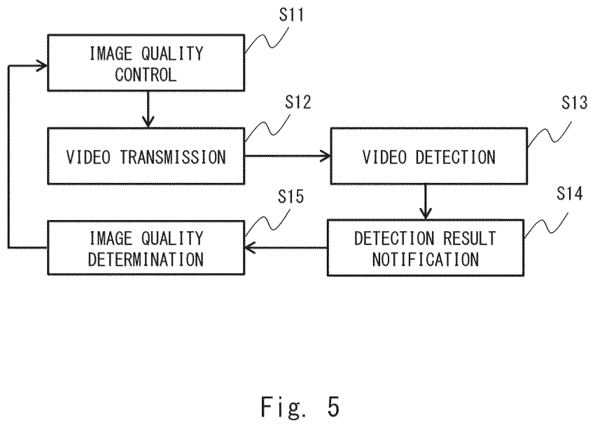

FIG. 5 illustrates a video processing method according to the example embodiment. For example, the video processing method according to the example embodiment is executed by the image quality control apparatus 10 and the detection apparatus 20 of the video processing system 30 illustrated in FIGS. 1 to 3.

As illustrated in FIG. 5, first, the image quality control apparatus 10 controls the image quality of each region of the video (S11). The image quality control apparatus 10 detects an object from a camera video, and controls the image quality of the video on the basis of the detection result of the object. For example, the image quality control apparatus 10 sharpens a region including the object. Next, the image quality control apparatus 10 transmits the video having the controlled image quality to the detection apparatus 20 via the network (S12).

The detection apparatus 20 receives the transmitted video, and detects information regarding the object in the received video (S13). For example, the detection apparatus 20 recognizes an action of the object in the video. Next, the detection apparatus 20 notifies the image quality control apparatus 10 of the detected detection result via the network (S14). For example, the detection apparatus 20 sends a notification of an action recognition result of the object.

Next, the image quality control apparatus 10 determines the image quality of each region of the video to be controlled, according to the notified detection result (S15). For example, the image quality control apparatus 10 determines a region to be sharpened, according to the action recognition result of the detection apparatus 20. For example, a region in which the action has already been recognized is excluded from the sharpening region, and another region is determined as the sharpening region. In a case where there are a plurality of sharpening regions, the sharpening region may be narrowed down on the basis of the action recognition result. Further, the processing returns to S11, and the image quality control apparatus 10 controls the image quality of each region of the video on the basis of the determined image quality.

In a system that transmits a video from a terminal such as an image quality control apparatus to a server such as a detection apparatus, in a case where the video is transmitted from the terminal to the server, if there are many regions which are desired to be improved in image quality, it may be difficult to improve the image quality of all the regions. In this case, a bit rate cannot be lowered even if the bit rate is attempted to be lowered for a network situation and communication load reduction. For example, in a case where a large number of people appear in a video, or in a case where a construction machine or a tool as a recognition target occupies most of a screen, the bit rate cannot be lowered. On the other hand, on the server side, the recognition accuracy of the region with a reduced image quality is lowered, and thus the video cannot be entirely reduced in image quality. In this regard, in the example embodiment, the server notifies the terminal of the recognition result of the object or the action, and the terminal controls the image quality of each region of the video according to the recognition result. As a result, it is possible to secure necessary recognition accuracy while suppressing the bit rate (communication amount).

### Basic Configuration of Remote Monitoring System

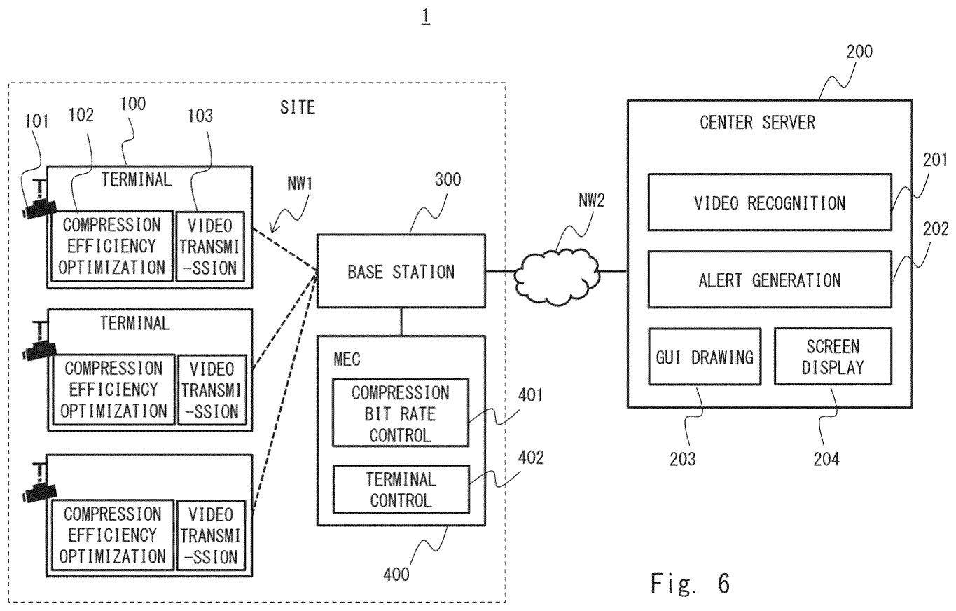

Next, a remote monitoring system which is an example of a system to which the example embodiment is applied will be described. FIG. 6 illustrates a basic configuration of a remote monitoring system 1. The remote monitoring system 1 is a system that monitors a captured area using a video captured by a camera. Hereinafter, the present example embodiment will be described as a system that remotely monitors work of a worker on-site. For example, the site may be an area where people and machines operate, such as a work site such as a construction site or a factory, a square where people gather, a station, or a school. In the present example embodiment, hereinafter, the work will be described as construction work, civil engineering work, or the like, but the work is not limited thereto. Note that, since the video includes a plurality of time-series images, that is, frames), the video and the image can be paraphrased with each other. That is, the remote monitoring system can be said to be a video processing system that processes a video and an image processing system that processes an image.

As illustrated in FIG. 6, the remote monitoring system 1 includes a plurality of terminals 100, a center server 200, a base station 300, and MEC 400. The terminal 100, the base station 300, and the MEC 400 are disposed at the site side, and the center server 200 is disposed on the center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network. The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video transmission apparatus that transmits on-site videos. In addition, the terminal 100 is an image quality control apparatus that controls the image quality of an on-site video. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency and a video transmission function 103. The compression efficiency optimization function 102 includes a region of interest (ROI) control to control image quality in the ROI in the video. The ROI is a predetermined region in the video. The ROI may be a region including a recognition target of a video recognition function 201 of the center server 200, or may be a region to be gazed at by the user. The compression efficiency optimization function 102 reduces the bit rate by reducing the image quality of the region around the ROI including the person or the object while maintaining the image quality of the ROI. The video transmission function 103 transmits a video having the controlled image quality to the center server 200. The compression efficiency optimization function 102 may include an image quality control unit that controls the image quality of each region of the video. The terminal 100 may include a transmission unit that transmits a video having the controlled image quality, and a determination unit that determines the image quality of each region of the video controlled by the image quality control unit.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 that controls a bit rate of the terminal and a terminal control function 402. The compression bit rate control function 401 controls a bit rate of the terminal 100 by adaptive video distribution control or quality of experience (QoE) control. The adaptive video distribution control is a video distribution control method for controlling a bit rate or the like of a video to be distributed according to a situation of a network. For example, the compression bit rate control function 401 predicts the recognition accuracy obtained in a case where the video is input to the recognition model by suppressing the bit rate of the distributed video, according to a communication environment of the networks NW1 and NW2, and allocates the bit rate to the video distributed by the camera 101 of each terminal 100 so as to improve the recognition accuracy. The terminal control function 402 controls the terminal 100 to transmit the video having the allocated bit rate. The terminal 100 encodes the video to have the allocated bit rate, and transmits the encoded video. Note that the control is not limited to the control of the bit rate, and the frame rate of the video to be distributed may be controlled according to the situation of the network.

The center server 200 is a server installed on the center side of the system. The center server 200 may be one or a plurality of physical servers, a cloud server built on a cloud, or other virtualization servers. The center server 200 is a monitoring apparatus that monitors on-site work by analyzing and recognizing a camera video of the site. The center server 200 is also a video reception apparatus that receives a video transmitted from the terminal 100. In addition, the center server 200 is a detection apparatus that detects an object or the like from a video of which image quality is controlled by the terminal 100.

The center server 200 has a video recognition function 201, an alert generation function 202, a GUI drawing function 203, and a screen display function 204. The video recognition function 201 inputs the video transmitted from the terminal 100 to a video recognition artificial intelligence (AI) engine, thereby recognizing the work performed by the worker, that is, the type of action of the person. The video recognition function 201 may include a detection unit that detects information regarding an object in a video. The center server 200 may include a notification unit that notifies the terminal 100 of the detection result of the detection unit.

The alert generation function 202 generates an alert according to the recognized work. The GUI drawing function 203 displays a graphical user interface (GUI) on a screen of the display apparatus. The screen display function 204 displays a video, a recognition result, an alert, and the like of the terminal 100 on the GUI. Note that any of the functions may be omitted or any of the functions may be included as necessary. For example, the center server 200 may not include the alert generation function 202, the GUI drawing function 203, and the screen display function 204.

### First Example Embodiment

Next, a first example embodiment will be described. In the present example embodiment, an example will be described in which a sharpening region is determined on the basis of an action recognition result.

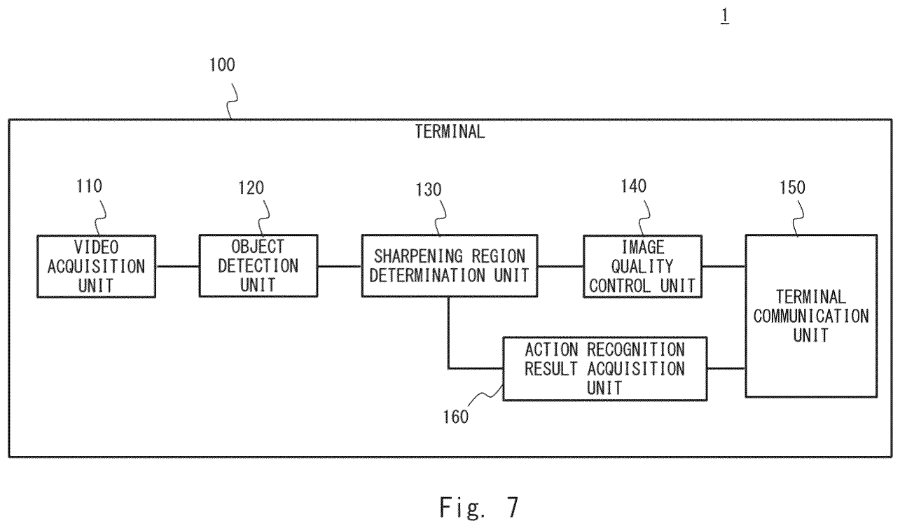

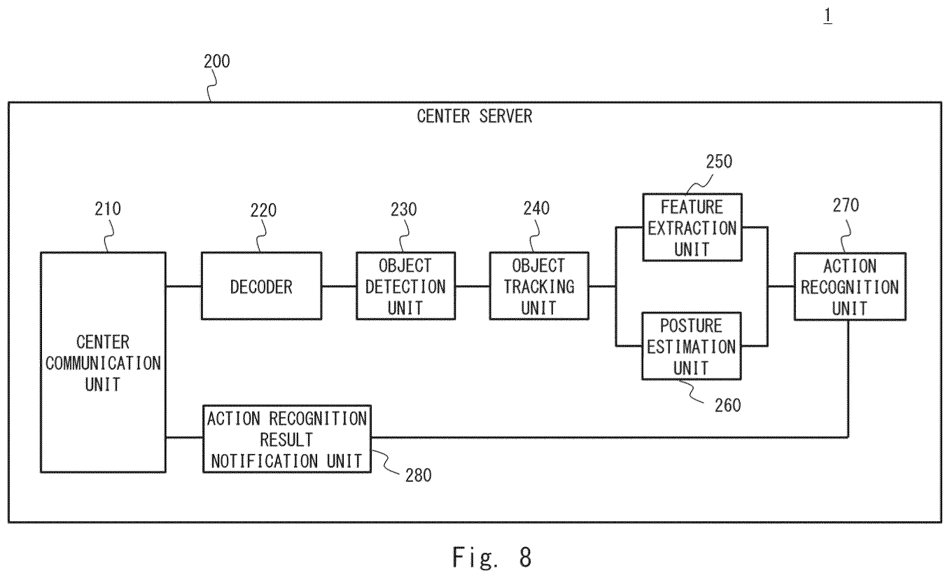

First, a configuration of a remote monitoring system according to the present example embodiment will be described. A basic configuration of the remote monitoring system 1 according to the present example embodiment is as illustrated in FIG. 6. Here, a configuration example of the terminal 100 and the center server 200 will be described. FIG. 7 illustrates a configuration example of the terminal 100 according to the present example embodiment, and FIG. 8 illustrates a configuration example of the center server 200 according to the present example embodiment.

Note that the configuration of each apparatus is an example, and another configuration may be used as long as the operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 including the compression bit rate control function may be disposed in the center server 200, the terminal 100, or the like. In addition, the center server 200 may be mounted on a cloud.

As illustrated in FIG. 7, the terminal 100 includes a video acquisition unit 110, an object detection unit 120, the object detection unit 120, a sharpening region determination unit 130, an image quality control unit 140, a terminal communication unit 150, and an action recognition result acquisition unit 160. For example, the terminal 100 corresponds to the image quality control apparatus 10 in FIG. 1.

The video acquisition unit 110 acquires a video captured by the camera 101. The video captured by the camera is hereinafter also referred to as an input video. For example, the input video includes a person who is a worker who performs work on-site, a work object used by the person, and the like. The video acquisition unit 110 is also an image acquisition unit that acquires a plurality of time-series images, that is, frames.

The object detection unit 120 detects an object in the acquired input video. The object detection unit 120 detects an object in each image included in the input video and recognizes the type of the detected object. The object type may be represented by an object label or an object class. For example, the object detection unit 120 may identify the type of the object in the video and assign a label or a class corresponding to the identified type. The object detection unit 120 extracts a rectangular region including an object from each image included in the input video, and recognizes an object type of the object in the extracted rectangular region. The rectangular region is a bounding box or an object region. Note that the object region including the object is not limited to the rectangular region, and may be a region having a circular or amorphous silhouette, or the like. The object detection unit 120 calculates a feature amount of an image of the object included in the rectangular region, and recognizes the object on the basis of the calculated feature amount. For example, the object detection unit 120 recognizes the object in the image by an object recognition engine using machine learning such as deep learning. The object can be recognized by performing machine learning on the feature of the image of the object and the type of the object. The detection result of the object includes an object type, position information of the rectangular region including the object, a score of the object type, and the like. The position information of the object is, for example, coordinates of each vertex of the rectangular region, and may be a position of the center of the rectangular region or a position of a certain point of the object. The score of the object type is the certainty of the detected object type, that is, the reliability or the certainty.

The action recognition result acquisition unit 160 acquires an action recognition result received by the terminal communication unit 150 from the center server 200. The action recognition result includes an action type, a score of the action type, a type of an object of the recognized action, position information of a rectangular region including the object, and the like. The action type may be represented by an action label or an action class. For example, a label or a class corresponding to the type of action recognized from the video may be assigned. The score of the action type is the certainty of the recognized action type, that is, the reliability or the certainty. The object indicated by the action recognition result is, for example, a person who is a target of action recognition, but may include a work object used by the person in work. In addition, the action recognition result may include an image, a feature amount, an importance level, and the like of a region of the object. The importance level is the importance level of the recognized action, and may be a priority level for sharpening.

The sharpening region determination unit 130 determines a sharpening region for enhancing image quality in the acquired input video on the basis of the detection result of the object detected in the input video. The sharpening region determination unit 130 may determine the regions of all the detected objects as sharpening regions. In addition, the sharpening region determination unit 130 may determine the sharpening region on the basis of the position information of an object having a predetermined object type among detection objects detected in the input video. For example, the region of an object having the object type in a gaze target list stored in the storage unit of the terminal 100 may be selected as the sharpening region. In addition, the region of an object having a score of the object type larger than a predetermined value or the regions of a predetermined number of objects from the top in descending order of the score of the object type may be selected as the sharpening region.

In addition, in a case where the sharpening region determination unit 130 acquires the action recognition result from the center server 200, the sharpening region determination unit 130 corresponds to the determination unit 13 in FIG. 1. A sharpening region in the input video is determined on the basis of the acquired action recognition result. For example, the sharpening region determination unit 130 may determine the sharpening region on the basis of only the detection result of the object or only the action recognition result, or may determine the sharpening region on the basis of the detection result of the object and the action recognition result. For example, the sharpening region may be determined by narrowing down the regions selected on the basis of the detection result of the object on the basis of the action recognition result. In a case where the action recognition result has not been acquired from the center server 200, for example, in a stage before the center server 200 performs action recognition, the sharpening region may be determined on the basis of only the detection result of the object. As described later, in a case where acquiring the action recognition result, the sharpening region determination unit 130 switches the sharpening region in the input video on the basis of the acquired action recognition result. For the region indicated by the position information of the object included in the action recognition result, the sharpening region determination unit 130 determines whether or not to sharpen the region according to whether or not the action of the object is recognized. In a case where a plurality of objects is detected from the input video, matching between the region where the object is detected and the region indicated by the action recognition result may be performed, and it may be determined whether or not to sharpen the object detection region narrowed down by a matching result. For example, in a case where the action of the object is recognized, the region indicated by the recognition result is excluded from the sharpening regions, and another region is selected as the sharpening region. In addition, in a case where the action of the object is not recognized, the region indicated by the recognition result is selected as the sharpening region. That is, the sharpening of the region indicated by the recognition result is continued. For example, whether or not the action of the object is recognized may be determined on the basis of the score of the action type of the action recognition result. In addition, in a case where the action recognition result includes an importance level, the sharpening region determination unit 130 may determine the sharpening region according to the importance level. For example, a priority level may be assigned to each region according to the action type and the importance level, and the sharpening region may be determined on the basis of the assigned priority level. In this case, the region having the highest priority level may be determined as the sharpening region, or a predetermined number of regions from the top in descending order of priority level may be determined as the sharpening region. In addition, a time for sharpening the region indicated by the action recognition result may be determined according to the action recognition result. For example, a time for sharpening may be associated with each action in advance, and the time for sharpening or a time excluded from sharpening may be determined according to the action type of the action recognition result. Note that the center server 200 may determine the sharpening region according to the action recognition result, and the terminal 100 may be notified of information regarding the sharpening region from the center server.

The image quality control unit 140 controls the image quality of the input video on the basis of the determined sharpening region. For example, the image quality control unit 140 corresponds to the image quality control unit 11 in FIG. 1. The sharpening region is a region where the image quality is enhanced compared to that of other regions, that is, a high image quality region where the image quality is improved compared to that of other regions. The sharpening region is also the ROI. The other regions are low image quality regions or non-sharpening regions. The image quality control unit 140 is an encoder that encodes the input video by a predetermined encoding system. The image quality control unit 140 performs encoding by a video encoding system such as H.264 or H.265, for example. The image quality control unit 140 compresses each of the sharpening region and other regions at a predetermined compression rate, that is, a bit rate, thereby performing encoding such that the image quality of the sharpening region has a predetermined quality. That is, the sharpening region is improved in image quality compared to other regions by changing the compression rate between the sharpening region and the other regions. It can also be said that the other regions are reduced in image quality compared to the sharpening region. For example, the image quality can be reduced by making a change in pixel value between adjacent pixels gentle.

In addition, the image quality control unit 140 may encode the input video to obtain the bit rate allocated from the compression bit rate control function 401 of the MEC 400. The image quality of the high image quality region and the low image quality region may be controlled within an allocated bit rate range. In addition, the image quality control unit 140 may determine the bit rate on the basis of communication quality between the terminal 100 and the center server 200. The image quality of the high image quality region and the low image quality region may be controlled within a bit rate range based on the communication quality. The communication quality is, for example, a communication speed, but may be another index such as a transmission delay or an error rate. The terminal 100 may include a communication quality measurement unit that measures communication quality. For example, the communication quality measurement unit determines the bit rate of the video to be transmitted from the terminal 100 to the center server 200 according to the communication speed. The communication speed may be measured on the basis of the data amount received by the base station 300 or the center server 200, and the communication quality measurement unit may acquire the measured communication speed from the base station 300 or the center server 200. In addition, the communication quality measurement unit may estimate the communication speed on the basis of the data amount per unit time transmitted from the terminal communication unit 150.

The terminal communication unit 150 transmits the encoded data encoded by the image quality control unit 140 to the center server 200 via the base station 300. The terminal communication unit 150 is a transmission unit that transmits a video having controlled image quality. For example, the terminal communication unit 150 corresponds to the transmission unit 12 in FIG. 1. In addition, the terminal communication unit 150 is also a reception unit that receives, via the base station 300, the action recognition result transmitted from the center server 200. The terminal communication unit 150 is an interface capable of communicating with the base station 300, and is, for example, a radio interface of 4G, local 5G/5G, LTE, a radio LAN, or the like, and may be a radio or wired interface of any other communication scheme. The terminal communication unit 150 may include a first terminal communication unit that transmits encoded data and a second terminal communication unit that receives an action recognition result. The first terminal communication unit and the second terminal communication unit may be communication units of the same communication scheme, or may be communication units of different communication schemes.

In addition, as illustrated in FIG. 8, the center server 200 includes a center communication unit 210, a decoder 220, an object detection unit 230, an object tracking unit 240, a feature extraction unit 250, a posture estimation unit 260, an action recognition unit 270, and an action recognition result notification unit 280. For example, the center server 200 corresponds to the detection apparatus 20 in FIG. 2.

The center communication unit 210 receives, via the base station 300, the encoded data transmitted from the terminal 100. The center communication unit 210 is a reception unit that receives a video having controlled image quality. In addition, the center communication unit 210 is also a transmission unit that transmits the action recognition result recognized by the action recognition unit 270 to the terminal 100 via the base station 300. The center communication unit 210 is an interface capable of communicating with the Internet or a core network, and is, for example, a wired interface for IP communication, and may be a wired or radio interface of any other communication scheme. The center communication unit 210 may include a first center communication unit that receives encoded data and a second center communication unit that transmits an action recognition result. The first center communication unit and the second center communication unit may be communication units of the same communication scheme, or may be communication units of different communication schemes.

The decoder 220 decodes the encoded data received from the terminal 100. The decoder 220 is a decoding unit that decodes encoded data. The decoder 220 is also a restoration unit that restores the encoded data, that is, the compressed data by a predetermined encoding system. The decoder 220 is compatible with the encoding system of the terminal 100, and performs decoding by a moving image encoding system such as H.264 or H.265. The decoder 220 decodes the video according to the compression rate or the bit rate of each region, and generates a decoded video. The decoded video is hereinafter also referred to as a received video.

The object detection unit 230 detects an object in the received video received from the terminal 100. For example, similarly to the object detection unit 120 of the terminal 100, the object detection unit 230 recognizes an object by an object recognition engine using machine learning. That is, the object detection unit 230 extracts a rectangular region including an object from each image of the received video, and recognizes the object type of the object in the extracted rectangular region. The detection result of the object includes an object type, position information of the rectangular region including the object, a score of the object type, and the like.

The object tracking unit 240 tracks the detected object in the received video. The object tracking unit 240 performs object matching of each image included in the received video on the basis of the object detection result, and associates the objects matched in each image with each other. For example, each object may be identified and tracked by assigning a tracking ID to the detected object. For example, an object is tracked by associating objects between images based on a distance or overlap between a rectangular region of an object detected in a previous image and a rectangular region of an object detected in a next image.

The feature extraction unit 250 extracts a feature amount of an image of an object for each object tracked by the object tracking unit 240. The feature extraction unit 250 extracts a feature amount used by the action recognition unit 270 to recognize an action of an object. The feature amount of a two-dimensional space of the image or the feature amount of a time space in a time direction may be extracted. For example, the feature extraction unit 250 extracts the feature amount of the image of the object by a feature extraction engine using machine learning such as deep learning. The feature extraction engine may be a convolutional neural network (CNN), a recurrent neural network (RNN), or another neural network.

The posture estimation unit 260 estimates a posture of an object for each object tracked by the object tracking unit 240. The posture estimation unit 260 may estimate, as the posture of the object, a skeleton of a person who is the detected object. For example, the posture estimation unit 260 estimates the posture of the object in the image by a skeleton estimation engine or a posture estimation engine using machine learning such as deep learning.

The action recognition unit 270 recognizes the action of the object on the basis of the feature extraction result and the posture estimation result. For example, the action recognition unit 270 corresponds to the detection unit 21 in FIG. 2. Note that the object detection unit 230 may correspond to the detection unit 21 in FIG. 2. The action recognition unit 270 recognizes the action of the object on the basis of the extracted feature amount of the image of the object and the estimated posture of the object. For example, work performed by a person using an object, an unsafe action which causes a person to be in a dangerous state, and the like are recognized. Note that not only the action recognition but also other video recognition processing may be used. The action recognition unit 270 recognizes a type of an action of an object for each object. For example, the action recognition unit 270 recognizes the action of the object by an action recognition engine using machine learning such as deep learning. By performing machine learning of the feature of the video of the person performing work and the action type, it is possible to recognize the action of the person in the video. The action recognition engine may be a CNN or an RNN, or another neural network. As described above, the action recognition result includes the action type, a score of the action type, a type of an object, position information of the object, and the like. The type and position information of the object are the type and position information of the object detected by the object detection unit 230. The action recognition result may include an image or a feature amount of a region of the detected object. In addition, an importance level may be associated with the action type or the object type, and the importance level corresponding to the recognized action type or object type may be included in the action recognition result.

The action recognition result notification unit 280 notifies the terminal 100 of an action recognition result that is a result of recognizing the action of the object. For example, the action recognition result notification unit 280 corresponds to the notification unit 22 in FIG. 2. The action recognition result notification unit 280 transmits the action recognition result output by the action recognition unit 270 to the terminal 100 via the center communication unit 210.

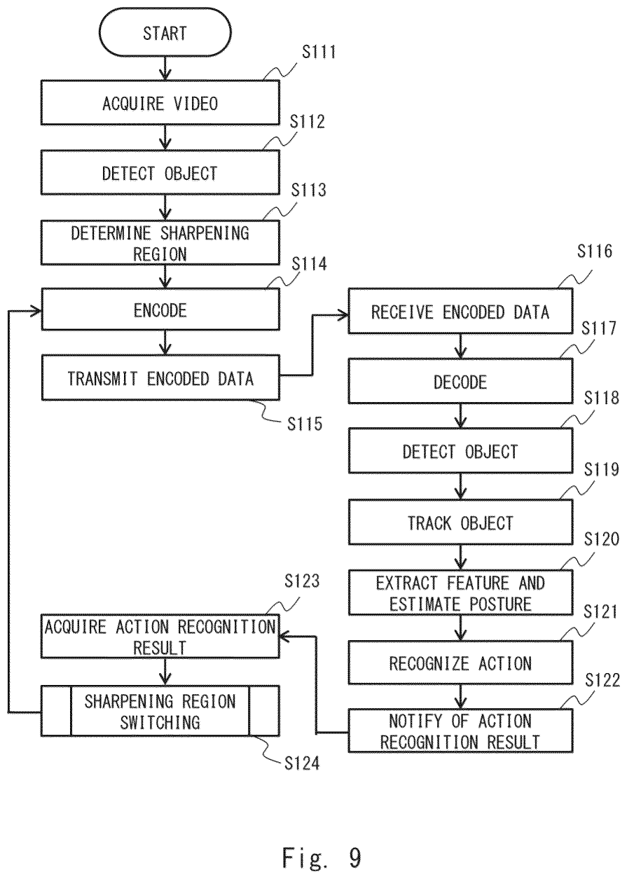

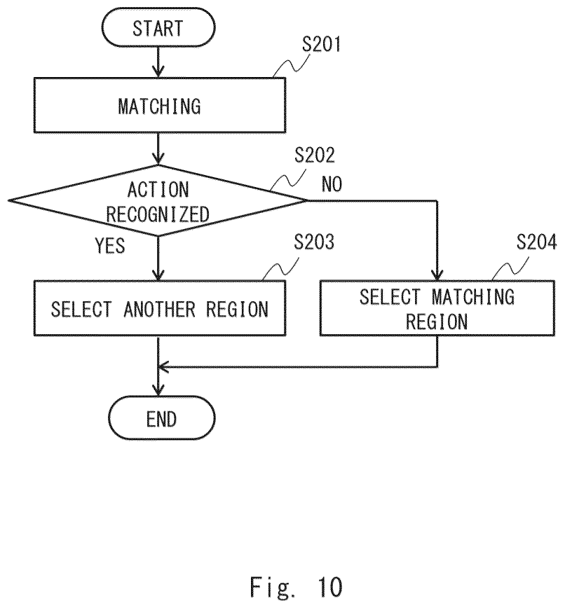

Next, an operation of the remote monitoring system according to the present example embodiment will be described. FIG. 9 illustrates an operation example of the remote monitoring system 1 according to the present example embodiment, and FIG. 10 illustrates an operation example of sharpening region switching processing (S124) of FIG. 9. For example, description will be made on the assumption that the terminal 100 executes S111 to S115 and S123 to S124, and the center server 200 executes S116 to S122, but the present invention is not limited thereto, and any apparatus may execute each processing.

As illustrated in FIG. 9, the terminal 100 acquires a video from the camera 101 (S111). The camera 101 generates a video obtained by imaging the site, and the video acquisition unit 110 acquires a video, that is, input video output from the camera 101. For example, as illustrated in FIG. 11, the image of the input video includes three persons P1 to P3 who perform work on-site. For example, the person P3 performs work with a hammer.

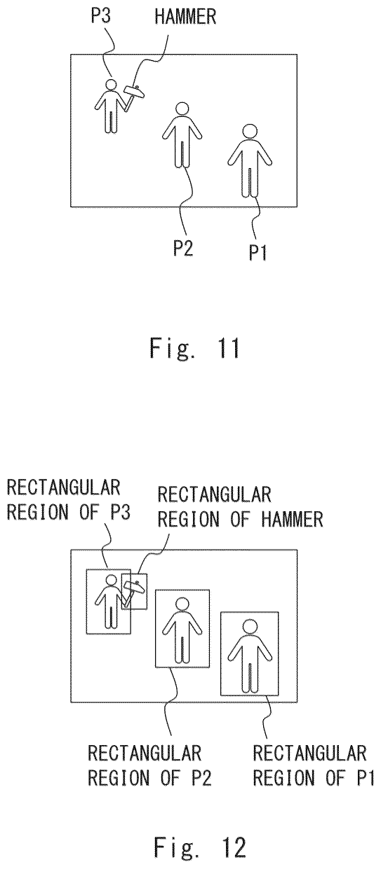

Subsequently, the terminal 100 detects an object on the basis of the acquired input video (S112). The object detection unit 120 detects a rectangular region in an image included in the input video using the object recognition engine, and recognizes an object type of an object in the detected rectangular region. For each detected object, the object detection unit 120 outputs an object type, position information of the rectangular region of the object, a score of the object type, and the like as the object detection result. For example, in a case where object detection is performed on the image of FIG. 11, the persons P1 to P3 and a hammer are detected, and the rectangular region of the persons P1 to P3 and the rectangular region of the hammer are detected as illustrated in FIG. 12.

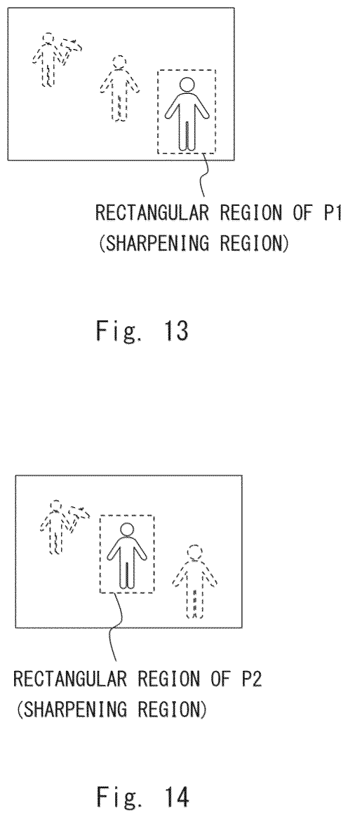

Subsequently, the terminal 100 determines the sharpening region on the basis of the object detection result (S113). At this stage, the center server 200 has not yet recognized an action from the video, and thus the sharpening region is determined without using an action recognition result. For example, the sharpening region determination unit 130 may determine, as the sharpening region, regions of all objects or a region of an object having a predetermined object type. In addition, the sharpening region determination unit 130 may determine, as the sharpening region, a region of an object in which the score of the object type is larger than a predetermined value. The region of the object selected as the sharpening region is set as a sharpening region currently being selected. For example, in the example of FIG. 12, in a case where the score of the person P1 is larger than the predetermined value and the scores of the person P2, the person P3, and the hammer are smaller than the predetermined value, the rectangular region of the person P1 is determined as the sharpening region as illustrated in FIG. 13.

Subsequently, the terminal 100 encodes the input video on the basis of the determined sharpening region (S114). The image quality control unit 140 encodes the input video by a predetermined video encoding system. For example, the image quality control unit 140 may encode the input video at a bit rate allocated from the compression bit rate control function 401 of the MEC 400, or may encode the input video at a bit rate corresponding to the communication quality between the terminal 100 and the center server 200. The image quality control unit 140 encodes the input video in a range of the allocated bit rate or the bit rate corresponding to the communication quality, such that the sharpening region has higher image quality than other regions. For example, the compression rate of the sharpening region is reduced to be lower than the compression rate of the other regions, so that the sharpening region is improved in image quality, and the other regions are reduced in image quality. As illustrated in FIG. 13, in a case where the rectangular region of the person P1 is selected as the sharpening region, the rectangular region of the person P1 is improved in image quality, and other regions including the person P2, the person P3, and the hammer are reduced in image quality.

Subsequently, the terminal 100 transmits the encoded data, which is encoded, to the center server 200 (S115), and the center server 200 receives the encoded data (S116). The terminal communication unit 150 transmits the encoded data obtained by encoding the input video, to the base station 300. The base station 300 transfers the received encoded data to the center server 200 via the core network or the Internet. The center communication unit 210 receives the transferred encoded data from the base station 300.

Subsequently, the center server 200 decodes the received encoded data (S117). The decoder 220 decodes the encoded data according to the compression rate or the bit rate of each region, and generates a decoded video, that is, a received video.

Subsequently, the center server 200 detects an object in the received video on the basis of the received video being received (S118). The object detection unit 230 detects the object in the received video using an object recognition engine. The object detection unit 230 outputs the type of the detected object, the position information of the rectangular region including the object, the score of the object type, and the like as the object detection result.

Subsequently, the center server 200 tracks the detected object in the received video (S119). The object tracking unit 240 tracks the object in the received video on the basis of the object detection result of the received video. The object tracking unit 240 assigns a tracking ID to each detected object, and tracks the object identified by the tracking ID with each image.

Subsequently, the center server 200 extracts a feature amount of an image of the object for each tracked object, and estimates a posture of the object (S120). The feature extraction unit 250 extracts the feature amount of the image of the tracked object using the feature extraction engine. The posture estimation unit 260 estimates the posture of the tracked object using the posture estimation engine.

Subsequently, the center server 200 recognizes an action of the object on the basis of the feature extraction result and the posture estimation result (S121). The action recognition unit 270 recognizes the action of the object in the received video on the basis of the extracted feature amount of the object and the estimated posture of the object using the action recognition engine. The action recognition unit 270 outputs a type of the recognized action of the object, position information of the object, a score of the action type, and the like as the action recognition result. For example, as illustrated in FIG. 13, in a case where the rectangular region of the person P1 is improved in image quality, the person P1 is detected and tracked, and the action of the person P1 is recognized based on the feature amount and the posture of the person P1.

Subsequently, the center server 200 notifies the terminal 100 of the recognized action recognition result (S122), and the terminal 100 acquires the action recognition result (S123). The action recognition result notification unit 280 notifies the terminal of the action recognition result output by the action recognition unit 270 via the center communication unit 210. The center communication unit 210 transmits the action recognition result to the base station 300 via the Internet or the core network. The base station 300 transfers the received action recognition result to the terminal 100. The terminal communication unit 150 receives the transferred action recognition result from the base station 300. The action recognition result acquisition unit 160 acquires the action recognition result received by the terminal communication unit 150.

Subsequently, the terminal 100 performs sharpening region switching processing of switching a sharpening region on the basis of the acquired action recognition result (S124). In the sharpening region switching processing, the sharpening region determination unit 130 selects a sharpening region on the basis of the action recognition result and switches the sharpening region determined in S113. Note that it may be determined whether or not to execute the sharpening region switching processing. For example, in a case where a predetermined time has elapsed from the previous execution of the sharpening region switching processing, in a case where a predetermined object or action has been recognized, or in a case where the regions of all the objects have been sharpened, the sharpening region switching processing may not be executed. In this case, the sharpening region currently being selected may be reset, and the sharpening region may be determined on the basis of the object detection result, similarly to S113.

In the sharpening region switching processing, as illustrated in FIG. 10, the sharpening region determination unit 130 performs matching between the acquired action recognition result and the object detection result of the input video (S201). That is, the center server 200 performs matching between the object of which the action has been recognized and the object detected by the terminal 100, and extracts, from among the detected objects, an object matching the object of which the action has been recognized. The sharpening region determination unit 130 compares the object of the action recognition result with the object of the object detection result, and determines whether or not the object of which the action has been recognized and the detected object are the same, that is, match each other. The sharpening region determination unit 130 performs matching on the basis of, for example, the type of the object, the position information of the object, and the like. For example, in a case where the types of objects match and a distance between the objects is equal to or less than a predetermined threshold value, it is determined that the objects match each other. Further, the feature amount of the image of the object may be used to determine matching in a case where the image of the object is similar. Note that in a case where the matching object cannot be extracted, the sharpening region may be determined on the basis of the object detection result, similarly to S113.

Next, the sharpening region determination unit 130 determines whether or not the action of the object matching with the action recognition result has been recognized (S202). The sharpening region determination unit 130 determines that the action has been recognized in a case where the score of the action type included in the action recognition result is larger than a predetermined value, and determines that the action has not been recognized in a case where the score of the action type is smaller than the predetermined value.

If it is determined that the action has been recognized, the sharpening region determination unit 130 selects another region as the sharpening region (S203). In a case where the action is recognized, the sharpening region determination unit 130 excludes the region of the matched object, that is, the region of the object currently selected as the sharpening region from the sharpening region, selects a region of another object as the sharpening region, and switches the sharpening region. The region of the object newly selected as the sharpening region is set as the sharpening region currently being selected. In a case where regions of a plurality of objects are detected, a region to be sharpened next is selected from the regions not selected as the sharpening region, and the region of the object to be selected is sequentially switched every time the action is recognized. The region to be sharpened next may be selected on the basis of the object type detected by the object detection or the score of the object type, or may be selected randomly. Note that in a case where there is no region to be sharpened next, or a case where the action type is a predetermined action, the current selection of the sharpening region may be maintained without switching the sharpening region to another region. That is, in this case, the region of the matched object may be selected as the sharpening region.

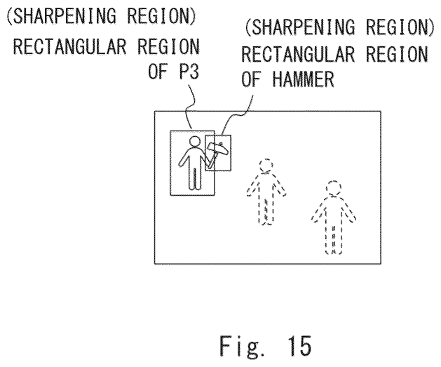

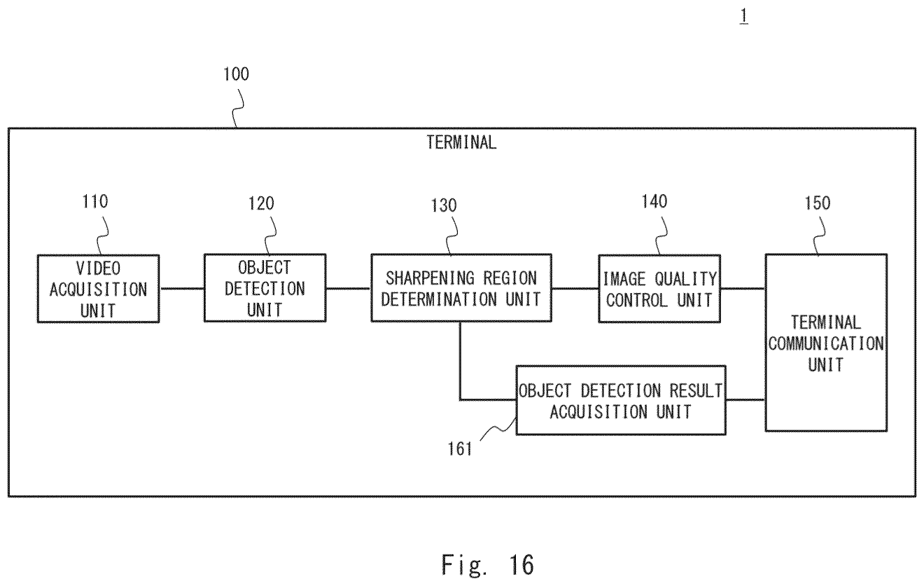

In the example of FIG. 13, in a case where the action of the person P1 is recognized, the region of the person P3 is excluded from the sharpening region, and any one of the person P2, the person P3, or the hammer is selected as the sharpening region. For example, the scores of the object types of the person P2, the person P3, and the hammer are compared from the object detection result, and in a case where the score of the object type of the person P2 is large, the rectangular region of the person P2 is determined as the sharpening region as illustrated in FIG. 14. Thereafter, in a case where the action of the person P2 has been recognized, the rectangular regions of the person P3 and the hammer are determined as the sharpening regions as illustrated in FIG. 15.

In addition, if it is determined that the action has not been recognized, the sharpening region determination unit 130 selects the region of the matched object as the sharpening region (S204). That is, in this case, the current selection of the sharpening region is maintained. For example, in the example of FIG. 13, in a case where the action of the person P1 is not recognized, a state where the rectangular region of the person P1 is selected as the sharpening region is continued. Thereafter, the processing from S114 is repeated.

As described above, in the present example embodiment, the sharpening region to be sharpened by the terminal is determined on the basis of the action recognition result of the center server. For example, a region that can be recognized by the center server is once excluded from the sharpening region, and another region that cannot be recognized is preferentially selected as the sharpening region. As a result, an important region can be narrowed down based on the object detection result of the terminal and the action recognition result of the center server, and the sharpening region can be shifted from the recognized region to the unrecognized region. By lowering a priority level of sharpening for the region having been recognized by the center server, it is possible to recognize actions in a larger range, and thus, it is possible to reduce missing of recognition. Therefore, it is possible to appropriately reduce the data amount of the video transmitted from the terminal while securing the recognition accuracy of the action recognition.

### Second Example Embodiment

Next, a second example embodiment will be described. In the present example embodiment, an example will be described in which a sharpening region is determined on the basis of an object detection result. Note that the present example embodiment can be implemented in combination with the first example embodiment, and each component described in the first example embodiment may be appropriately used.

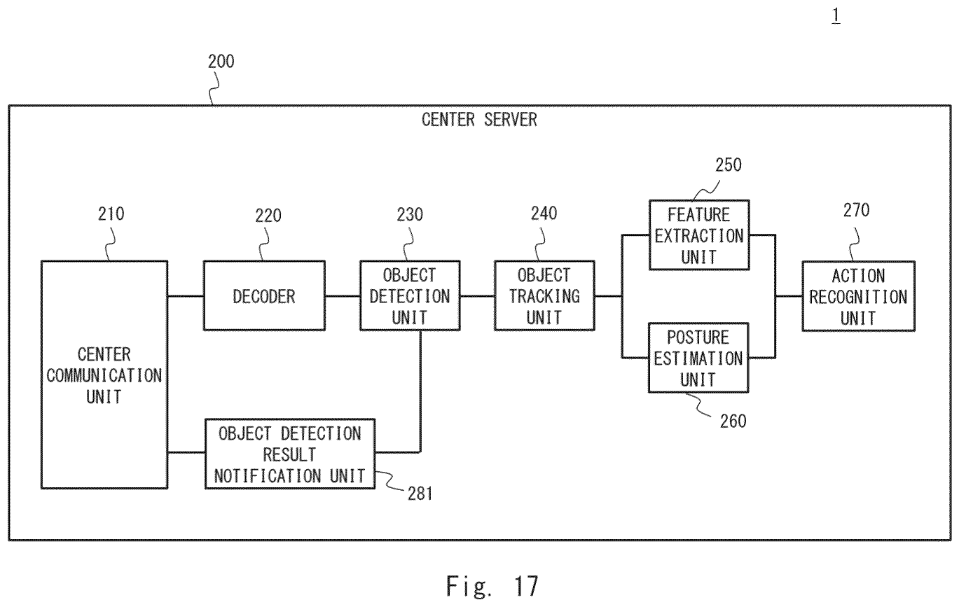

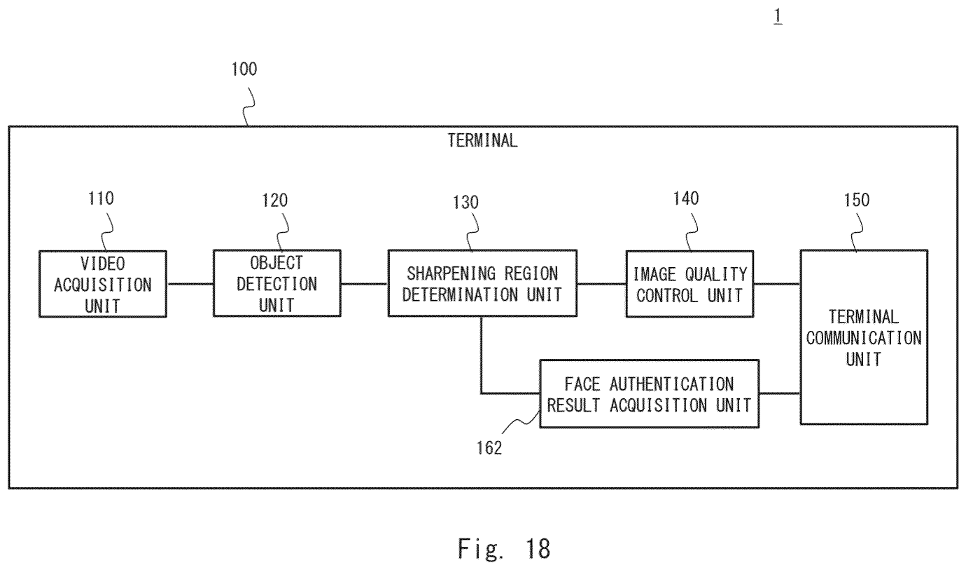

FIG. 16 illustrates a configuration example of the terminal 100 according to the present example embodiment, and FIG. 17 illustrates a configuration example of the center server 200 according to the present example embodiment. Here, a configuration different from that of the first example embodiment will be mainly described.

As illustrated in FIG. 16, the terminal 100 includes an object detection result acquisition unit 161 instead of the action recognition result acquisition unit 160 of the first example embodiment. In addition, as illustrated in FIG. 17, the center server 200 includes an object detection result notification unit 281 instead of the action recognition result notification unit 280 of the first example embodiment. Other components are similar to those in the first example embodiment. Note that the terminal 100 may further include the object detection result acquisition unit 161 in addition to the configuration of the first example embodiment. The center server 200 may further include the object detection result notification unit 281 in addition to the configuration of the first example embodiment.

The object detection result notification unit 281 of the center server 200 notifies the terminal 100 of the object detection result detected by the center server 200. The object detection result notification unit 281 transmits the object detection result output by the object detection unit 230 to the terminal 100 via the center communication unit 210. The object detection result includes an object type, position information of a rectangular region including an object, a score of the object type, and the like.

The object detection result acquisition unit 161 of the terminal 100 acquires the object detection result received from the center server 200 via the terminal communication unit 150. The sharpening region determination unit 130 determines a sharpening region in the input video on the basis of the acquired object detection result. The method for determining the sharpening region on the basis of the object detection result is similar to the method for determining the sharpening region on the basis of the action recognition result of the first example embodiment. That is, the sharpening region determination unit 130 determines whether or not to sharpen the region indicated by the position information of the object included in the object detection result according to whether or not the object is detected. In a case where the object is detected, for example, in a case where the score of the object type is larger than a predetermined value, the region indicated by the detection result is excluded from the sharpening region, and another region is selected as the sharpening region. In addition, in a case where no object is detected, for example, in a case where the score of the object type is smaller than the predetermined value, the region indicated by the detection result is selected as the sharpening region.

As described above, in the present example embodiment, the sharpening region to be sharpened by the terminal is determined on the basis of the object detection result of the center server. Even in this case, similarly to the first example embodiment, it is possible to appropriately reduce the data amount of the video while securing the detection accuracy of the object detection.

### Third Example Embodiment

Next, a third example embodiment will be described. In the present example embodiment, an example will be described in which a sharpening region is determined on the basis of a face authentication result. Note that the present example embodiment can be implemented in combination with the first or second example embodiment, and each configuration described in the first or second example embodiment may be appropriately used.

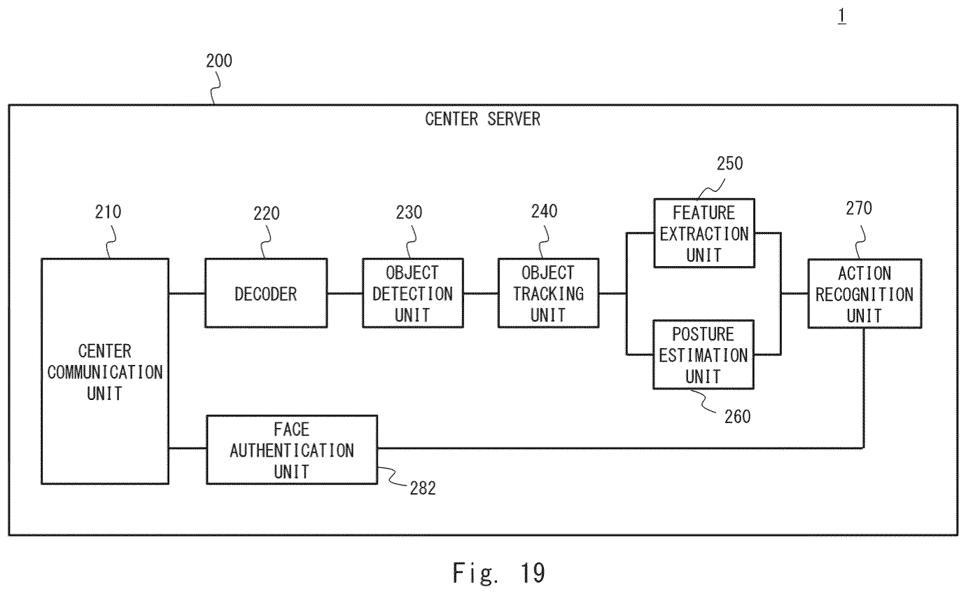

FIG. 18 illustrates a configuration example of the terminal 100 according to the present example embodiment, and FIG. 19 illustrates a configuration example of the center server 200 according to the present example embodiment. Here, a configuration different from that of the first example embodiment will be mainly described. Note that the present example embodiment may be applied to the second example embodiment.

As illustrated in FIG. 18, the terminal 100 includes a face authentication result acquisition unit 162 instead of the action recognition result acquisition unit 160 of the first example embodiment. In addition, as illustrated in FIG. 19, the center server 200 includes a face authentication unit 282 instead of the action recognition result notification unit 280 of the first example embodiment. Other components are similar to those in the first example embodiment. Note that the terminal 100 may further include the face authentication result acquisition unit 162 in addition to the configuration of the first example embodiment. The center server 200 may further include the face authentication unit 282 in addition to the configuration of the first example embodiment.

The face authentication unit 282 of the center server 200 performs face authentication of a person detected by object detection. For example, an image of the face of a person and identification information for identifying the person are stored in the storage unit in association with each other. The face authentication unit 282 extracts the face of the person in the video, and collates the extracted face with the face of the person registered in the storage unit. For example, the face authentication unit 282 may authenticate the face of the person in the image by a face authentication engine using machine learning such as deep learning. The face authentication unit 282 transmits the matching rate of the face authentication and the position information of the person as the face authentication result to the terminal 100 via the center communication unit 210.

The face authentication result acquisition unit 162 of the terminal 100 acquires the face authentication result received from the center server 200 via the terminal communication unit 150. The sharpening region determination unit 130 determines a sharpening region in the input video on the basis of the acquired face authentication result. The sharpening region determination unit 130 determines whether or not to sharpen the region indicated by the position information of the person included in the face authentication result according to whether or not the face is authenticated. In a case where the face is authenticated, for example, in a case where the matching rate is larger than a predetermined value, the region indicated by the face authentication result is excluded from the sharpening region, and another region is selected as the sharpening region. In addition, in a case where the face is not authenticated, for example, in a case where the matching rate is smaller than the predetermined value, the region indicated by the face authentication result is selected as the sharpening region.

As described above, in the present example embodiment, the sharpening region to be sharpened by the terminal is determined on the basis of the face authentication result of the center server. Even in this case, similarly to the first and second example embodiments, it is possible to appropriately reduce the data amount of the video while securing the accuracy of the action recognition and the object detection.

Note that the present disclosure is not limited to the above-described example embodiments, and can be appropriately modified without departing from the scope.

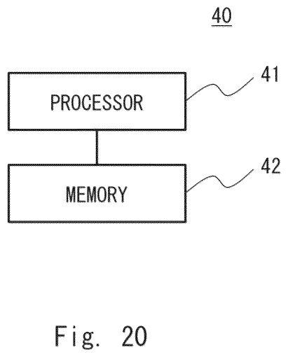

Each configuration in the above-described example embodiments may be implemented by hardware, software, or both, and may be implemented by one piece of hardware or software or by a plurality of pieces of hardware or software. The apparatuses and functions (processing) may be realized by a computer 40 including a processor 41, such as a central processing unit (CPU), and a memory 42, which is a storage device, as illustrated in FIG. 20. For example, programs for performing the methods (video processing method) in the example embodiments may be stored in the memory 42 and the functions may be realized by the processor 41 executing the programs stored in the memory 42.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, the transitory computer-readable medium or communication medium includes electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system including:
an image quality control apparatus; and
a detection apparatus, in which
the image quality control apparatus includes
an image quality control means for controlling image quality of each region of a video, and
a transmission means for transmitting, to the detection apparatus, the video of which the image quality is controlled,
the detection apparatus includes
a detection means for detecting information regarding an object in the video transmitted from the transmission means, and
a notification means for notifying the image quality control apparatus of a detection result of the detection means, and
the image quality control apparatus further includes
a determination means for determining the image quality of each region of the video according to the detection result notified from the notification means, the image quality being controlled by the image quality control means.

### Supplementary Note 2

The video processing system according to Supplementary Note 1, in which
the detection means detects an object in the video as the information regarding the object, and
the determination means determines the image quality of each region of the video according to a detection result of the object, the image quality being controlled by the image quality control means.

### Supplementary Note 3

The video processing system according to Supplementary Note 1 or 2, in which
the detection means recognizes an action of an object in the video as the information regarding the object, and
the determination means determines the image quality of each region of the video according to a recognition result of the action of the object, the image quality being controlled by the image quality control means.

### Supplementary Note 4

The video processing system according to any one of Supplementary Notes 1 to 3, in which the determination means determines the image quality of each region of the video according to whether the information regarding the object is detected by the detection means.

### Supplementary Note 5

The video processing system according to Supplementary Note 4, in which in a case where the information regarding the object is detected by the detection means, the determination means changes an image quality of a region where the object is detected and an image quality of other regions.

### Supplementary Note 6

The video processing system according to Supplementary Note 4 or 5, in which in a case where the information regarding the object is not detected by the detection means, the determination means maintains the image quality of each region of the video.

### Supplementary Note 7

A video processing method in a video processing system including an image quality control apparatus and a detection apparatus, in which
the image quality control apparatus
controls image quality of each region of a video, and
transmits, to the detection apparatus, the video of which the image quality is controlled,
the detection apparatus
detects information regarding an object in the transmitted video, and
notifies the image quality control apparatus of the detected detection result, and
the image quality control apparatus
determines the image quality of each region of the video to be controlled, according to the notified detection result.

### Supplementary Note 8

The video processing method according to Supplementary Note 7, in which
the detection apparatus detects an object in the video as the information regarding the object, and
the image quality control apparatus determines the image quality of each region of the video to be controlled, according to a detection result of the object.

### Supplementary Note 9

The video processing method according to Supplementary Note 7 or 8, in which
the detection apparatus recognizes an action of an object in the video as the information regarding the object, and
the image quality control apparatus determines the image quality of each region of the video to be controlled, according to a recognition result of the action of the object.

### Supplementary Note 10

The video processing method according to any one of Supplementary Notes 7 to 9, in which the image quality control apparatus determines the image quality of each region of the video according to whether the information regarding the object is detected.

### Supplementary Note 11

The video processing method according to Supplementary Note 10, in which in a case where the information regarding the object is detected, the image quality control apparatus changes an image quality of a region where the object is detected and an image quality of other regions.

### Supplementary Note 12

The video processing method according to Supplementary Note 10 or 11, in which the image quality control apparatus maintains the image quality of each region of the video in a case where the information regarding the object is not detected.

### Supplementary Note 13

An image quality control apparatus including:
an image quality control means for controlling image quality of each region of a video;
a transmission means for transmitting the video of which the image quality is controlled, to a detection apparatus configured to detect information regarding an object in the video; and
a determination means for determining the image quality of each region of the video according to a detection result notified from the detection apparatus, the image quality being controlled by the image quality control means.

### Supplementary Note 14

The image quality control apparatus according to Supplementary Note 13, in which
the detection apparatus detects an object in the video as the information regarding the object, and
the determination means determines the image quality of each region of the video according to a detection result of the object, the image quality being controlled by the image quality control means.

### Supplementary Note 15

The image quality control apparatus according to Supplementary Note 13 or 14, in which
the detection apparatus recognizes an action of an object in the video as the information regarding the object, and
the determination means determines the image quality of each region of the video according to a recognition result of the action of the object, the image quality being controlled by the image quality control means.

### Supplementary Note 16

The image quality control apparatus according to any one of Supplementary Notes 13 to 15, in which the determination means determines the image quality of each region of the video according to whether the information regarding the object is detected by the detection apparatus.

### Supplementary Note 17

The image quality control apparatus according to Supplementary Note 16, in which in a case where the information regarding the object is detected by the detection apparatus, the determination means changes an image quality of a region where the object is detected and an image quality of other regions.

### Supplementary Note 18

The image quality control apparatus according to Supplementary Note 16 or 17, in which in a case where the information regarding the object is not detected by the detection apparatus, the determination means maintains the image quality of each region of the video.

### REFERENCE SIGNS LIST

1 REMOTE MONITORING SYSTEM
10 IMAGE QUALITY CONTROL APPARATUS
11 IMAGE QUALITY CONTROL UNIT
12 TRANSMISSION UNIT
13 DETERMINATION UNIT
20 DETECTION APPARATUS
21 DETECTION UNIT
22 NOTIFICATION UNIT
30 VIDEO PROCESSING SYSTEM
40 COMPUTER
41 PROCESSOR
42 MEMORY
100 TERMINAL
101 CAMERA
102 COMPRESSION EFFICIENCY OPTIMIZATION FUNCTION
103 VIDEO TRANSMISSION FUNCTION
110 VIDEO ACQUISITION UNIT
120 OBJECT DETECTION UNIT
130 SHARPENING REGION DETERMINATION UNIT
140 IMAGE QUALITY CONTROL UNIT
150 TERMINAL COMMUNICATION UNIT
160 ACTION RECOGNITION RESULT ACQUISITION UNIT
161 OBJECT DETECTION RESULT ACQUISITION UNIT
162 FACE AUTHENTICATION RESULT ACQUISITION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 OBJECT DETECTION UNIT
240 OBJECT TRACKING UNIT
250 FEATURE EXTRACTION UNIT
260 POSTURE ESTIMATION UNIT
270 ACTION RECOGNITION UNIT
280 ACTION RECOGNITION RESULT NOTIFICATION UNIT
281 OBJECT DETECTION RESULT NOTIFICATION UNIT
282 FACE AUTHENTICATION UNIT
300 BASE STATION
400 MEC
401 COMPRESSION BIT RATE CONTROL FUNCTION
402 TERMINAL CONTROL FUNCTION

What is claimed is:

1. A video processing system comprising:
an image quality control apparatus; and
a detection apparatus, wherein
the image quality control apparatus includes
a first memory configured to store first instructions, and
a first processor configured to execute the first instructions to;
control image quality of each region of a video, and
transmit, to the detection apparatus, the video of which the image quality is controlled,
the detection apparatus includes
a second memory configured to store second instructions, and
a second processor configured to execute the second instructions to;
detect information regarding an object in the video transmitted from the image quality control apparatus, and
notify the image quality control apparatus of the detected detection result, and
the first processor is further configured to execute the first instructions to
determine the image quality of each region of the video to be controlled according to the detection result notified from the detection apparatus.

2. The video processing system according to claim 1, wherein
the secon processor is further configured to execute the second instructions to detect an object in the video as the information regarding the object, and
the first processor is further configured to execute the first instructions to determine the image quality of each region of the video to be controlled according to a detection result of the object.

3. The video processing system according to claim 1, wherein
the secon processor is further configured to execute the second instructions to recognize an action of an object in the video as the information regarding the object, and
the first processor is further configured to execute the first instructions to determine the image quality of each region of the video to be controlled according to a recognition result of the action of the object.

4. The video processing system according to claim 1, wherein the first processor is further configured to execute the first instructions to determine the image quality of each region of the video according to whether the information regarding the object is detected by the detection apparatus.

5. The video processing system according to claim 4, wherein in a case where the information regarding the object is detected by the detection apparatus, the first processor is further configured to execute the first instructions to change an image quality of a region where the object is detected and an image quality of other regions.

6. The video processing system according to claim 4, wherein in a case where the information regarding the object is not detected by the detection apparatus, the first processor is further configured to execute the first instructions to maintain the image quality of each region of the video.

7. A video processing method in a video processing system including an image quality control apparatus and a detection apparatus, wherein
the image quality control apparatus
controls image quality of each region of a video, and
transmits, to the detection apparatus, the video of which the image quality is controlled,
the detection apparatus
detects information regarding an object in the transmitted video, and
notifies the image quality control apparatus of the detected detection result, and
the image quality control apparatus
determines the image quality of each region of the video to be controlled, according to the notified detection result.

8. The video processing method according to claim 7, wherein
the detection apparatus detects an object in the video as the information regarding the object, and
the image quality control apparatus determines the image quality of each region of the video to be controlled, according to a detection result of the object.

9. The video processing method according to claim 7, wherein
the detection apparatus recognizes an action of an object in the video as the information regarding the object, and
the image quality control apparatus determines the image quality of each region of the video to be controlled, according to a recognition result of the action of the object.

10. The video processing method according to claim 7, wherein the image quality control apparatus determines the image quality of each region of the video according to whether the information regarding the object is detected.

11. The video processing method according to claim 10, wherein in a case where the information regarding the object is detected, the image quality control apparatus changes an image quality of a region where the object is detected and an image quality of other regions.

12. The video processing method according to claim 10, wherein the image quality control apparatus maintains the image quality of each region of the video in a case where the information regarding the object is not detected.

13. An image quality control apparatus comprising:
a memory configured to store instructions, and
a processor configured to execute the instructions to;
control image quality of each region of a video;
transmit the video of which the image quality is controlled, to a detection apparatus configured to detect information regarding an object in the video; and
determine the image quality of each region of the video to be controlled according to a detection result notified from the detection apparatus.

14. The image quality control apparatus according to claim 13, wherein
the detection apparatus detects an object in the video as the information regarding the object, and
the processor is further configured to execute the instructions to determine the image quality of each region of the video to be controlled according to a detection result of the object.

15. The image quality control apparatus according to claim 13, wherein
the detection apparatus recognizes an action of an object in the video as the information regarding the object, and
the processor is further configured to execute the instructions to determine the image quality of each region of the video to be controlled according to a recognition result of the action of the object.

16. The image quality control apparatus according to claim 13, wherein the processor is further configured to execute the instructions to determine the image quality of each region of the video according to whether the information regarding the object is detected by the detection apparatus.

17. The image quality control apparatus according to claim 16, wherein in a case where the information regarding the object is detected by the detection apparatus, the processor is further configured to execute the instructions to change an image quality of a region where the object is detected and an image quality of other regions.

18. The image quality control apparatus according to claim 16, wherein in a case where the information regarding the object is not detected by the detection apparatus, the processor is further configured to execute the instructions to maintain the image quality of each region of the video.
